SEQUENCE LISTING (3 sequences)

SEQ ID NO: 1 - protein, 451 aa, Homo sapiens
MRECISIHVGQAGVQIGNACWELYCLEHGIQPDGQMPSDKTIGGGDDSFNTFFSETGAGKHVPRAVFVDLEPTVIDEVRTGTYRQLFHPEQLITGKEDAANNYARGHYTIGKEIIDLVLDRIRKLADQCTGLQGFLVFHSFGGGTGSGFTSLLMERLSVDYGKKSKLEFSIYPAPQVSTAVVEPYNSILTTHTTLEHSDCAFMVDNEAIYDICRRNLDIERPTYTNLNRLIGQIVSSITASLRFDGALNVDLTEFQTNLVPYPRIHFPLATYAPVISAEKAYHEQLSVAEITNACFEPANQMVKCDPRHGKYMACCLLYRGDVVPKDVNAAIATIKTKRTIQFVDWCPTGFKVGINYQPPTVVPGGDLAKVQRAVCMLSNTTAIAEAWARLDHKFDLMYAKRAFVHWYVGEGMEEGEFSEAREDMAALEKDYEEVGVDSVEGEGEEEGEEY

SEQ ID NO: 2 - protein, 6 aa, Artificial Sequence
  TSHR epitope
QAFDSH

SEQ ID NO: 3 - protein, 12 aa, Artificial Sequence
  repeat sequence of NF-kapp-b activating protein
KKRRKKKSSKRK

(19) United States
(12) Patent Application Publication
(10) Pub. No.: US 2019/0050524 A1
(43) Pub. Date: Feb. 14, 2019

(54) ENHANCED APPLICATIONS OF MOLECULAR LIBRARIES BASED ON STRUCTURE/FUNCTION ANALYSIS

(71) Applicant: ARIZONA BOARD OF REGENTS ON BEHALF OF ARIZONA STATE UNIVERSITY, Scottsdale, AZ (US)

(72) Inventor: Neal Woodbury, Tempe, AZ (US)

(21) Appl. No.: 16/057,040

(22) Filed: Aug. 7, 2018

Related U.S. Application Data
(60) Provisional application No. 62/543,107, filed on Aug. 9, 2017.

(51) Int. Cl. G06F 19/16; C40B 30/04; G06F 19/18

(52) U.S. Cl. CPC G06F 19/16; G06F 19/18; C40B 30/04

(57) ABSTRACT

Methods and applications for relating the structure of a molecule in a library to its function are described. Embodiments described herein relate structure to function by considering the covalent structure of the molecule, the components of that structure that are common to many molecules in the library, and the properties of those components as they relate to the function in question. Applications include, for example, enhancement and amplification of the diagnostic and prognostic signals provided by peptide arrays for use in analyzing the profile of antibodies in the blood produced in response to a disease, condition or treatment.

### CROSS REFERENCE TO RELATED APPLICATIONS

This application claims priority to U.S. Provisional Application No. 62/543,107 filed on Aug. 9, 2017, which is incorporated herein by reference in its entirety for all purposes.

### STATEMENT REGARDING FEDERALLY SPONSORED RESEARCH

This invention was made with government support under 1243082 awarded by the National Science Foundation. The government has certain rights in the invention.

### BACKGROUND OF THE INVENTION

While many methods are known to those skilled in the art to prepare libraries of molecules and measure their functional properties, such approaches to relating the covalent structure of molecules in libraries to their function rely on the concept that the molecules can be described as a series of component pieces and those component pieces act more or less independently to give rise to function. A common example in the application of nucleic acid and peptide libraries is the derivation of a consensus motif, a description of a sequence of nucleotides or amino acids that assigns a position dependent functional significance to each.

However, many of the interactions in biology cannot be described by such simple models, and methods of considering higher order interactions between multiple components of a library molecule, both adjacent in the structure and distributed within the structure, with the ligand or functional activity in question are required.

### SUMMARY OF INVENTION

Embodiments herein involve methods for relating the structure of a molecule in a library to its function by analyzing experimental data from a library comprising one or more chemical structures.

For example, the method includes obtaining a data set associated with one or more chemical structures based on a signal derived from interaction of the one or more chemical structures with a physical phenomenon of interest and applying a model description to said data set that enables determination of a function of said molecule in the library according to values representing its covalent structure, one or more components of that structure, and one or more properties of the components as they relate to the function in question.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1. Results from a fit using equation 3 of binding data of the monoclonal antibody DM1A to an array of peptides. The peptide sequences used in this prediction are unique from those used in the fit. The Pearson correlation coefficient between the predicted and measured data is 0.90. Values shown are the log base 10 of measured values.

FIG. 2. Results from a fit using equation 4 of binding data of the monoclonal antibody DM1A to an array of peptides. The peptide sequences used in this prediction are unique from those used in the fit. The Pearson correlation coefficient between the predicted and measured data is 0.91.

FIG. 3. Calculated binding to human alpha tubulin using a fit to equation 4 of the peptide array. The known cognate epitope is the wide feature to the left, but there are a couple other prominent binding regions as well.

FIG. 4. Positions of the amino acids identified as strong binding by the calculation. All of these are present in close proximity (within 2 nm) of the known cognate sequence on the same surface of the protein.

FIG. 5. Calculated binding to alpha tubulin and 100 other similarly sized human proteins using a fit of the peptide array data (which did not contain any cognate sequences) bound to the monoclonal antibody DM1A. The highest binding protein is indeed alpha tubulin.

FIG. 6. The binding is shown as an inverse probability (based on binding rank), combining the probability of having multiple contiguous windows or frames of sequence all bind to the antibody.

FIG. 7. The dominance of the actual antigen is further enhanced by determining what sequences and most sensitive to point mutations and using that as an additional factor in calculating prominence of each sequence region in the list of proteins.

FIG. 8. Measured binding values vs. a fit to equation 4 of the average of the Hepatitis B and C patient data. The data was median normalized and the log base 10 was taken before fitting. The Pearson correlation between the measured and predicted values was 0.89. Note that the binding shown is from peptides that were on the array but not used in training the model.

FIG. 9. Measured binding values vs. a fit to equation 4 of the average of the Hepatitis B and C patient data. The data was median normalized but fit on a linear scale (not log). The Pearson correlation between the measured and predicted values was 0.78. Note that the binding shown is from peptides that were on the array but not used in training the model.

FIG. 10. Calculated binding of Hepatitis B patient serum (based on a fit using equation 4 of the average of 44 Hepatitis B infected samples) to a tiles set of peptides covering the Hepatitis B proteome. What is plotted on the y-axis is the rank-based probability of the observed binding value for each peptide.

FIG. 11. Map of specific sites in the Hepatitis B proteome where there were differential immune responses between Hepatitis B and Hepatitis C patients. The p-values were obtained from a 2-sided Ttest comparing the predicted binding of IgG in serum from Hepatitis B patients to a tiled set of peptides covering the Hepatitis B proteome to the predicted binding of Hepatitis C patients to the same tiled set of peptides.

FIG. 12. Receiver operator curve of support vector machine classification of the original measured binding data from the peptide array comparing 44 samples from Hepatitis B and 44 samples from Hepatitis C.

FIG. 13. Receiver operator curve of support vector machine classification of calculated binding data from the peptide array comparing 44 samples from Hepatitis B and 44 samples from Hepatitis C.

FIG. 14. Receiver operator curve of support vector machine classification of calculated binding data to the Hepatitis B tiled proteome comparing 44 samples from Hepatitis B and 44 samples from Hepatitis C.

FIG. 15. Receiver operator curve of support vector machine classification of original measured data from the peptide array divided by the calculated binding data to the peptide array comparing 44 samples from Hepatitis B and 44 samples from Hepatitis C.

FIG. 16. Receiver operator curve of support vector machine classification of original measured data from the peptide array divided by the calculated binding data to the peptide array as well as the values from the calculated binding to the peptide array comparing 44 samples from Hepatitis B and 44 samples from Hepatitis C.

FIG. 17. Scatter plot of predicted vs. measured values from a fit using equation 4 of the log 10 of median normalized binding data from transferring binding to a 330,000 peptide array. The predicted values are of sequences that were held out of the fit.

FIG. 18. Applications of the transferrin data fit to the prediction of binding to sequences that make up the transferrin receptor. The receptor sequence was broken into a set of overlapping 12 amino acid peptides and the equation was used to predict the binding to each of these peptides.

FIG. 19. Binding prediction for transferrin to the transferrin receptor after considering the fact that true specific binding sequences would persist in multiple sequence windows and be very sensitive to point mutation.

FIG. 20. Sequence in the transferrin receptor shown in red represents the two top binding regions in FIG. 19. These are both at the interface between the receptor and transferrin.

### DETAILED DESCRIPTION

The preferred embodiments are described with reference to the Figures, in which like numbers represent the same or similar elements. The described features, structures, or characteristics of the invention may be combined in any suitable manner in one or more embodiments. In the following description, numerous specific details are recited to provide a thorough understanding of embodiments disclosed herein. One skilled in the relevant art will recognize, however, that embodiments disclosed herein may be practiced without one or more of the specific details, or with other methods, components, materials, and so forth. In other instances, well-known structures, materials, or operations are not shown or described in detail to avoid obscuring inventive aspects. All publications recited herein are hereby incorporated by reference in their entirety.

Embodiments disclosed herein utilize one or more algorithms in methods for relating functional data from libraries of defined molecules to the structures of those molecules. The algorithms involve a three part description of the molecules in the library in terms of 1) covalent structure of each molecule, 2) a set of structural components that make up the molecules, and 3) a description of the properties of the structural components that relate them to the function in question. Using this formalism, it has been demonstrated that one can accurately predict the function of molecular species that are NOT present in the library that was fit to the algorithm, if those molecules can be described using the same component structures and associated properties as the molecules present in the libraries used to perform the fits.

Thus, embodiments disclosed herein related to the use of these algorithms in such a way that they improve the performance of molecular library technologies in a number of molecular array applications. These applications include but are not limited to:
Design of new molecular libraries with specific function
Screening of complex molecular systems of known structure for functional prediction
Discovery of potential lead compounds with desirable functions
Use in the development and implementation of diagnostic methods
Use in the development of therapeutics and vaccines

Specific embodiments are described which relate to an array of peptides (amino acid polymers) and their binding properties relative to both isolated antibodies and the total circulating antibody population in blood as well as to binding to other proteins of biological and biomedical interest. The specific applications of these embodiments include but are not limited to:
Design of peptide arrays that bind to specific antibodies or to antibodies in serum with specific properties such as the presence of antibodies expressed during a disease state
The enhancement and amplification of the diagnostic and prognostic signals provided by peptide arrays for use in analyzing the profile of antibodies in the blood produced in response to a disease, condition or treatment.
Discovery of protein antigens or polypeptide sequences that are responsible for the response to a disease, condition or treatment (e.g., discovery of antigens for a vaccine).
Discovery of protein antigens or polypeptide sequences that are responsible for adverse reactions resulting from a disease, condition or treatment (e.g., autoimmune reactions).
The discovery of lead compounds to be used in the development of therapeutics.
The discovery of potential targets of therapeutic treatment.
The characterization of specific antibodies, such as monoclonal antibodies used as therapeutics, to determine what peptide and protein sequences they are expected to bind
The discovery of protein antigens that could be used in the development of vaccines
The discovery of ligands appropriate for developing specific binding complexes to proteins or other molecular complexes.

### Molecular Libraries

There are many methods known to those skilled in the art to prepare libraries of molecules and measure their functional properties. These include but are not limited to phage display, RNA display, synthetic bead-based libraries, and other library techniques using synthesized molecules. The approach described here is applicable to any molecular library system in which the function in question can be measured for enough of the unique molecular species in the library to allow the fitting routine to properly converge. Specifically, the approach requires that the number of molecular species for which measurements are performed be greater, and preferably much greater, than the number of free parameters used in defining the algorithm. The number of free parameters in turn depends on the complexity of the structural and chemical model described by the algorithm.

Specific embodiments of this general approach herein are described involving large peptide arrays. The processes and analysis described, however, are not specific to peptide arrays and those skilled in the art will recognize that this is a general approach to molecular library analysis that can be used with any library of molecules for which the structure of some or all of the molecules in the library can be described in terms of a common set of structural features and a measured response of some kind can be associated with that structure. Molecular libraries could include but are not limited to peptides, nucleic acids, proteins, sugars and sugar polymers, any of the former with non-natural components (e.g., non-natural amino acids or nucleic acids), molecular polymers of known covalent structure, branched molecular structures and polymers, circular molecular structures and polymers, molecular systems of known composition created in part through self-assembly (e.g. structures created through hybridization to DNA or structures created via metal ion binding to molecular systems).

Measured responses include but are not limited to binding, chemical reactivity, catalytic activity, hydrophobicity, acidity, conductivity, electromagnetic absorbance, electromagnetic diffraction, fluorescence, magnetic properties, capacitance, dielectric properties, flexibility, toxicity to cells, inhibition of catalysis, inhibition of viral function, index of refraction, thermal conductivity, optical harmonic generation, resistance to corrosion, and resistance to or ease of hydrolysis.

A specific embodiment described here relates to peptide arrays which have been exposed either to individual antibodies or to blood or serum containing multiple antibodies. In this embodiment, antibodies bind to the array of peptides and are detected either directly (e.g. using fluorescently labeled antibodies) or by the binding of a labeled secondary antibody that binds to all of the antibodies of a specific time (e.g., IgG or IgM). Together, the signals produced from binding of antibodies to the features in the array form a pattern, with the binding to some peptides in the array much greater than to others. It should be noted that the arrays used in this embodiment have been extensively employed not only for antibody binding but for binding to other proteins, small molecules, whole viruses, whole bacteria and eukaryotic cells as well (See References 1-10). The methods described apply to all of these cases. The specific arrays used in this embodiment consisted of between 120,000 and 130,000 unique peptides. However larger and smaller sized libraries can be used as long as they meet the criteria described above. Array synthesis and binding assays in the examples given below were performed as has been described in the literature (See References 11-14). For some of the studies, the arrays were synthesized and or assays performed by the company HealthTell, Inc. For other studies the arrays were synthesized and/or assays performed in the Peptide Array Core at Arizona State University.

Algorithms that Relate the Structure of Molecular Species in a Library to their Measured Function

Most approaches to relating the covalent structure of molecules in libraries to their function rely on the concept that the molecules can be described as a series of component pieces and those component pieces act more or less independently to give rise to function. A common example in the application of nucleic acid and peptide libraries is the derivation of a consensus motif, a description of a sequence of nucleotides or amino acids that assigns a position dependent functional significance to each. However, many of the interactions in biology cannot be described by such simple models, and methods of considering higher order interactions between multiple components of a library molecule, both adjacent in the structure and distributed within the structure, with the ligand or functional activity in question are required. These higher order interactions are information rich processes, and thus to identify them requires the analysis of a large number of examples of interactions between the functional activity and many different library molecules.

The difficulty in designing models that do this accurately is that the models need to include high order interactions while at the same time not creating so many free parameters in the system so as to cause the problem to be under-determined.

Relating to the methods described herein, two algorithms have been developed that accomplish this goal. They are both based on the idea that the structure of a molecule in a library can be related to its function by considering three components: 1) the covalent structure of the molecule, 2) the components of that structure that are common to many molecules in the library and 3) the properties of those components as they relate to the function in question. Mathematically, this can be expressed as:

f_{n(sequence)}=ΣₘΣᵣΣₖC_{n,m,r}Q_{k,m}A_{k,r} (1)

Here, fₙ is the function of the nth molecule in the library, C_{n,m,r} is a description of the covalent structure of the molecule where n is again the specific molecule in the library, m represents chemical entities that make up the molecule and r represents the positions of a set of structural elements made from those entities. For a peptide in a library, m and r could simply designate specific amino acids at specific positions in a sequence. However, m could also represent groups of amino acids and r groups of structural arrangements of those amino acids. Q_{k,m} represents the assignment of properties to the chemical entities. There are k properties assigned to each of the m chemical entities. A_{k,r} represents the weighting coefficient assigned to the different functional components of the molecule in terms of their properties and relates these structures and properties to the measured function. This is fundamentally different from a description such as a consensus sequence, which might be described in a similar formalism as:

f_{n(sequence)}=ΣₘΣᵣC_{n,m,r}B_{m,r} (2)

Here components, for example individual amino acids, in the covalent structure are simply assigned a weight and added up.

The two algorithms described here both assign properties to each of the components that make up the molecular system (the Q term), translating discrete species (e.g. a set of amino acids or a set of nucleic acid monomers) into sets of properties with continuous values. Both then use a method for describing higher order interactions between components of the structures. For example, allowing for a specific property that arises only when there is an alanine in position 2 of a peptide at the same time that there is an arginine at position 7 and a valine at position 11. The difference between the algorithms is in the mechanisms that they use to describe these higher order interactions.

The first algorithm involves products of the sums described above. Here m simply represents an amino acid and r represents its position in the sequence. The higher order interactions arise in the products which generate cross terms and the cross terms represent interactions between components in the peptide that give rise to higher order properties. In this case, one performs a nonlinear optimization of the power series:

f_{n(sequence)}=α₀+α₁ΣₘΣᵣΣₖC_{n,m,r}Q_{k,m}A_{k,r}+α₂(ΣₘΣᵣΣₖC_{n,m,r}Q_{k,m}A_{k,r})(ΣₘΣᵣΣₖC_{n,m,r}Q_{k,m}A_{k,r})+α₃(ΣₘΣᵣΣₖC_{n,m,r}Q_{k,m}A_{k,r})(ΣₘΣᵣΣₖC_{n,m,r}Q_{k,m}A_{k,r})(ΣₘΣᵣΣₖC_{n,m,r}Q_{k,m}A_{k,r})+ . . . (3)

Here, α₀ is a multiplier of the term and the other variables are as noted above. Note that the A and Q matrices can either be held constant in every sum or different values can be used in each sum, depending on the complexity of the structure and function being described.

The second approach is similar in principle, but uses a different mechanism for introducing the higher order interactions. Here, the equation itself is a single sum:

f_{n(sequence)}=ΣₘΣᵣΣₖC_{n,m,r}Q_{k,m}A_{k,r} (4)

However, the descriptions used for the structure and chemical properties of the components involved in this model directly incorporate the higher order structural entities in the description of the sequence. C again contains the sequence information and is fixed, but it contains that information in terms of a basis set of structures and chemistries. As such the index ‘m’ in this model represents groupings of particular amino acids. This could be individual amino acids or pairs of amino acids or sets of three amino acids.

Consider a model in which we describe the peptide sequences in terms of groups of three amino acids. There are 8000 combinations of 3 amino acids possible and therefore the index ‘m’ would range from 1 to 8000. The index ‘r’ in this model represents the structural arrangements of three amino acids. This is in terms of the physical position of the amino acids in the peptide. Thus in a model that used three amino acids in each basis structure, the structures could be all possible ways of placing 3 amino acids into a 12 residue long peptide. There are 220 ways of selecting 3 distinct positions in a 12 residue peptide and so r would range from 1 to 220. Q assigns chemical properties (‘k’ of them) to each of the ‘m’ combinations of amino acids. These properties are usually left as free parameters in the fit. A provides a coefficient for every member in the basis set. Once C and Q are combined, one will have assigned a particular set of ‘k’ properties to each of the ‘r’ structures. If there were 4 properties and 220 possible structural arrangements then A would have dimensions of 4×220. So the total number of free parameters in the fit is given by the number of elements in Q (8000×4 in the example above) and A (4×220 in the example above). As will be described later, sometimes it is useful to define Q once and then hold it constant and calculate A for many different samples. However, as it turns out, there is sufficient information in a 126,000 peptide array to accurately determine both Q and A without too much overfitting.

As outlined above, an accurate description of an antibody binding to peptide sequences is very useful in many contexts. It allows one to generalize from a specific set of, e.g., 126,000 peptides to all other peptides of that general length scale (for a 12 residue peptide, this would predict the binding to 2012=4×1015 sequences). This can be used to predict binding to all possible sequences in a proteome, for instance, or to the sequences in a known antigen in order to map the epitope. As will be described below, it also organizes the binding information in useful ways, such that this information can more effectively used in enhancing the diagnostic capabilities of the peptide arrays when identifying disease states. A number of different nonlimiting examples are given below which exemplify the utility of processes that use the equations developed via the data analysis described above to accomplish important tasks useful in medicine, research and molecular design.

It should be noted that besides interactions with other chemicals, there could be interactions with physical phenomena that one may use to obtain a data set based on a signal derived from interaction of one or more chemical structures with a physical phenomenon of interest. Such phenomenon may include, by way of example, light, other types of electromagnetic radiation, ionic radiation, electric fields, magnetic fields, temperature changes, pressure changes, proximity to materials (which may or may not be molecular), particle beams, plasmas, exposure to fluxes of electrons, protons, positrons or other subatomic molecules, exposure to atoms, ions or radicals that are not molecular, sheer forces, surface tension, and so forth.

A nonlimiting example below will also demonstrate the ability to apply the same approaches to describe the binding of peptide sequences to a protein that is not an antibody. This approach can be used to predict binding of one protein to other proteins or binding partners (e.g., to a specific receptor on a cell) or to predict and refine specific ligands to proteins or other molecular complexes. These types of predictions may be useful in many different applications including, but not limited to, locating potential drug/vaccine targets, creating synthetic antibodies, developing specific labels (e.g. fluorescent labels, or labels used in medical imaging), developing antimicrobial/antiviral compounds or developing targeting molecules that could be attached to known drugs and give them high affinity and specificity for a desired target.

### Example 1, Characterizing a Monoclonal Antibody

Both equations (3) and (4) were used to a fit of the fluorescence data resulting from binding a labeled molecule of the monoclonal antibody DM1A (a monoclonal antibody for tubulin frequently used in histological staining of cells) to a peptide array. Commercial arrays (HealthTell, Inc.) were used for this purpose. They produce arrays of ˜126,000 unique peptides and bind either specific antibodies or serum to the arrays using assays which are standard in that company and essentially the same as those described in the literature (see References 11-14). In brief, the assay involves adjusting the concentration of sample by dilution into a standard buffer and applying this to an array of peptides on a silica surface that has been treated to decrease any background binding. The array is washed, a fluorescently labeled secondary antibody that will bind to the antibody or antibodies in the sample is then applied, excess washed off, and the array is dried and imaged on a commercial imaging system. The image is processed to provide a value of fluorescence intensity for each peptide on the array. The dynamic range of the assay is roughly 1000:1, depending on the sample and the background binding.

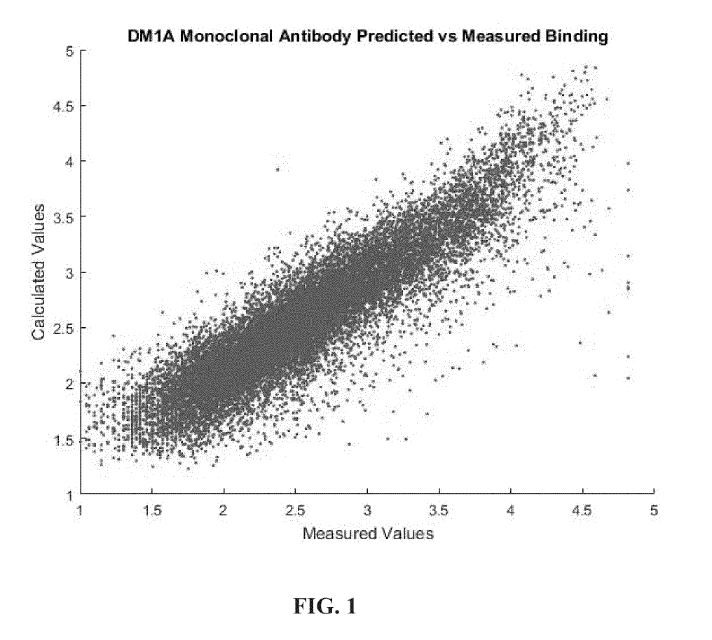

The results of fitting the binding data for the monoclonal antibody DM1A to equation 3 are shown in FIG. 1. On the x-axis is the log of the measured binding data. On the y-axis are the predicted values (also on a log base 10 scale). Note that these are true predictions. The binding data that was used to train the algorithm was based on a completely different set of peptide sequences than the peptide sequences being predicted here. The Pearson Correlation Coefficient between the predicted and measured values was 0.90.

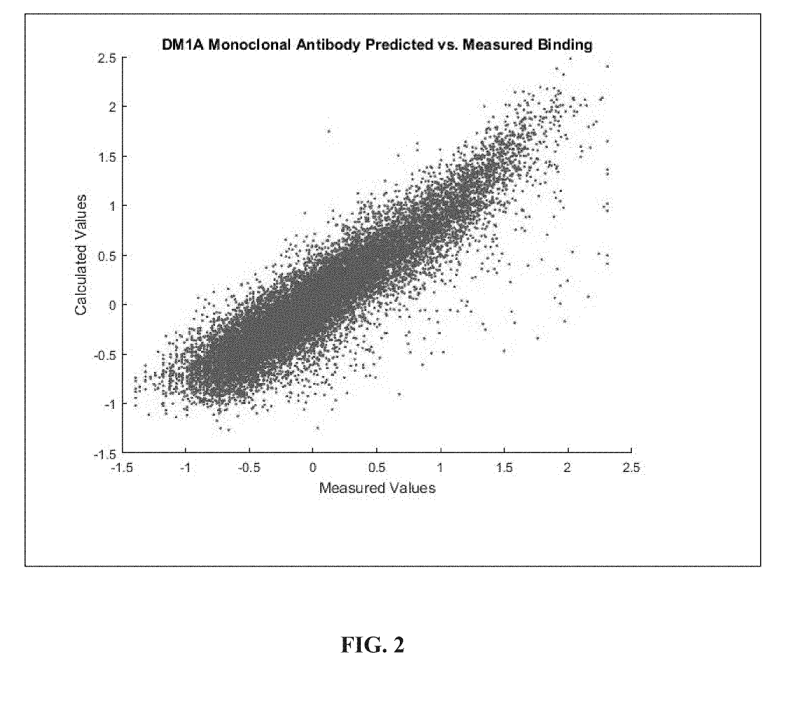

Similarly, equation (4) was applied to the same data set and the results of prediction (again of peptide sequences not used in the fit) is shown in FIG. 2. Note that in this case normalization to the median was performed before the log base 10 was taken of the data (hence the change in scale). Here the Pearson Correlation coefficient is 0.91.

One can use the fits from binding of a particular antibody to map the epitope(s) it interacts with in an antigen. The antigen that DM1A was raised to is human alpha tubulin. The amino acid sequence of tubulin is shown below and the known cognate epitope of DM1A is identified (bolded and underlined):

Alpha Tubulin Sequence Showing DM1A Epitope

(SEQ ID NO. 1)
MRECISIHVGQAGVQIGNACWELYCLEHGIQPDGQMPSDKTIGGGDDSFN
TFFSETGAGKHVPRAVFVDLEPTVIDEVRTGTYRQLFHPEQLITGKEDAA
NNYARGHYTIGKEIIDLVLDRIRKLADQCTGLQGFLVFHSFGGGTGSGFT
SLLMERLSVDYGKKSKLEFSIYPAPQVSTAVVEPYNSILTTHTTLEHSDC
AFMVDNEAIYDICRRNLDIERPTYTNLNRLIGQIVSSITASLRFDGALNV
DLTEFQTNLVPYPRIHFPLATYAPVISAEKAYHEQLSVAEITNACFEPAN
QMVKCDPRHGKYMACCLLYRGDVVPKDVNAAIATIKTKRTIQFVDWCPTG
FKVGINYQPPTVVPGGDLAKVQRAVCMLSNTTAIAEAWARLDHKFDLMYA
KRAFVHWYVGEGMEEGEFSEAREDMAALEKDYEEVGVDSVEGEGEEEGEE
Y

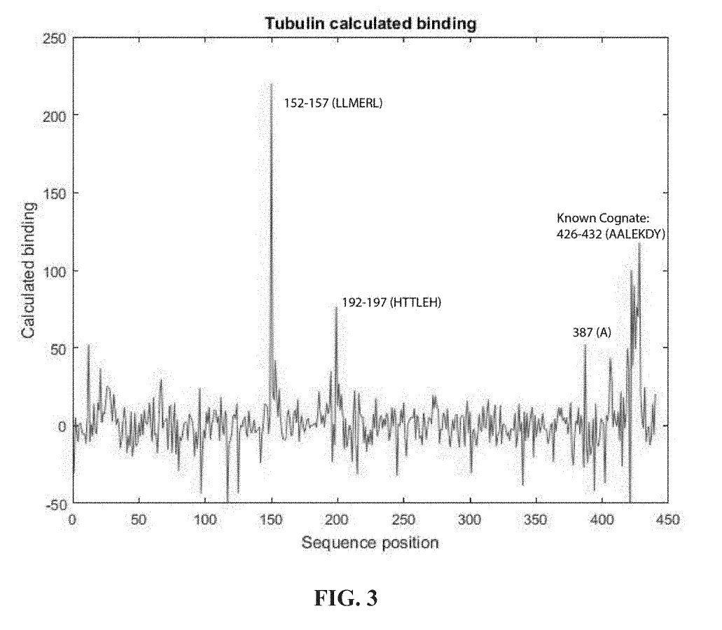

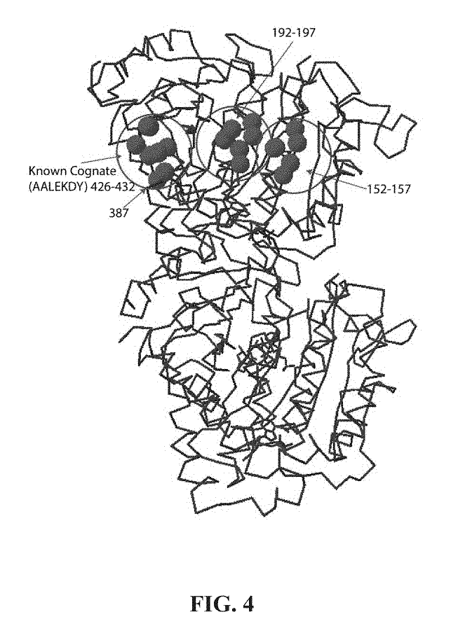

A map of the binding of DM1A predicted by a fit to equation 4 is shown in FIG. 3. Note that in FIG. 3, the prominent, wide feature to the right is the published cognate epitope. However, the fit identified some other significant potential binding sequences. FIG. 4 shows the positions of these sequences in the structure. Note that they are all in relatively close proximity on the surface of alpha tubulin, suggesting that they may indeed all be involved in stabilizing the binding of this monoclonal antibody.

### Example 2: Predicting the Antigen of an Isolated Antibody from a Group of Other Proteins

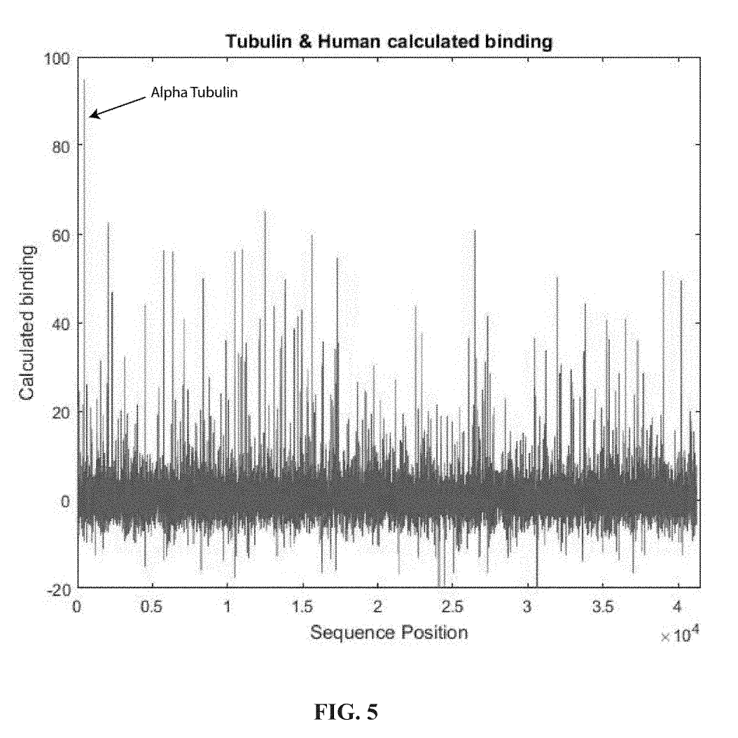

It is also possible to use fits such as the one above to identify the antigen of a specific antibody among a list of possible antigens. FIG. 5 shows the binding predicted by a fit using equation 4 of DMA1 binding to the alpha tubulin gene and 100 similarly sized human genes. Note that the sequences of the proteins are shown as contiguous and just numbered from the beginning to the end. Alpha tubulin is predicted to bind most strongly of all proteins sampled.

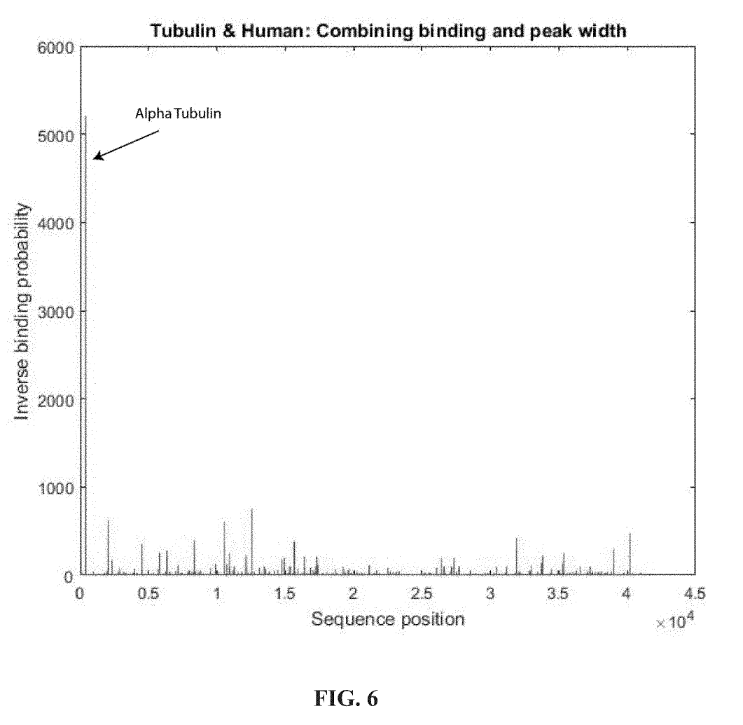

However, there are a number of other proteins that are not much weaker than alpha tubulin and if larger groups of proteins are considered, there could easily by stronger binding proteins. To better discriminate antigen binding from binding to less specific targets, one can take advantage of the biology of specific antibody binding. In particular, one generally might expect two characteristics of a true epitope. First, our algorithm considers binding over a window, in the case shown in FIG. 5, a 9 amino acid window was used. One would expect that the epitope might be present in multiple contexts within a large enough window. In other words, one would expect multiple contiguous windows would bind with similar intensity, as long as they contain the epitope (each binding signal is to a window of residues in the protein and from one point to the next, the window is shifted by one residue, so a particular epitope could be present in many such windows). To take advantage of this fact, we give a stronger weighting to binding events in which contiguous windows have substantial binding. The result of such a process is shown in FIG. 6. Here the binding is shown as an inverse probability calculated by considering the binding rank of each sequence among all sequences and then determining the probability of contiguous binding of several windows at high rank.

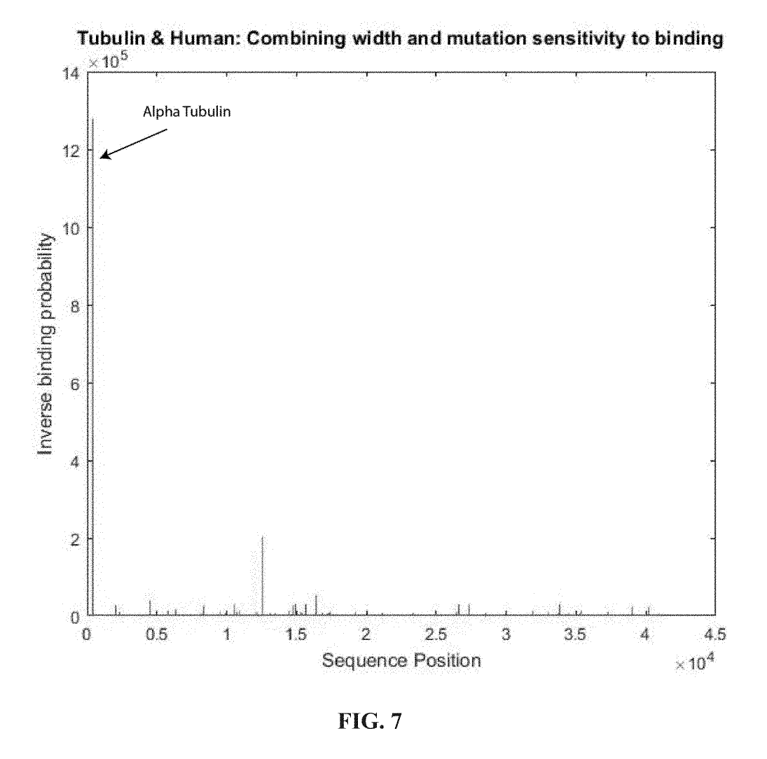

One can go one step farther in imposing biological constraints on the system. True epitopes are also usually very sensitive to point mutations. Because this is a calculated system, it is possible to calculate the effect of many point mutations on each sequence window in the list of 100 proteins and quantitate the effect of mutation. Again, the probability of high mutational sensitivity (again by rank) can be combined with the probability binding in multiple contiguous window, cleaning up the distinction farther as shown in FIG. 7. In this case, mutational sensitivity was determined for each peptide that had significant binding by replacing each amino acid with four other amino acids and taking a geometric average of the resulting fractional change that resulted.

Other biological criteria can also be incorporated into the process, again facilitated by the fact that we can calculate the expected behavior. As an example, the monoclonal antibody 4C1 (raised to thyroid stimulating hormone receptor, TSHR, having the cognate epitope QAFDSH (SEQ ID NO. 2) was analyzed using the same basic process outlined above. In this case, the epitopes identified as having the highest binding were from two proteins out the hundred human proteins plus TSHR. The highest ranked protein was human NF-kappa-B-activating protein which as a sequence in it that was a repeat of mostly lysine and arginine: KKRRKKKSSKRK (SEQ ID NO. 3). Long runs of positively charged amino acids were purposely excluded when designing the peptide arrays used in these studies. Apparently, this caused the calculated binding function to give an erroneous answer (there is always low level nonspecific binding associated highly positively charged species in the arrays picked up by the fit). However, one can scramble this sequence without much change in its binding and use that as a criterion for elimination; true epitopes depend not only on composition, but order. That effectively eliminates this sequence sending the TSHR sequence to the top of the list.

Thus a key point is that by having a general equation relating binding to sequence for an antibody, not only can one predict the binding to specific sequences in a large number of candidate antigens, but one can apply known biological constraints to the system, such as the need to bind in multiple contiguous sequence windows, the known sensitivity of true epitopes to point mutation, and the fact that true epitopes depend on order, not composition.

### Example 3 Determining the Epitopes that Distinguish Clinically Relevant Infections

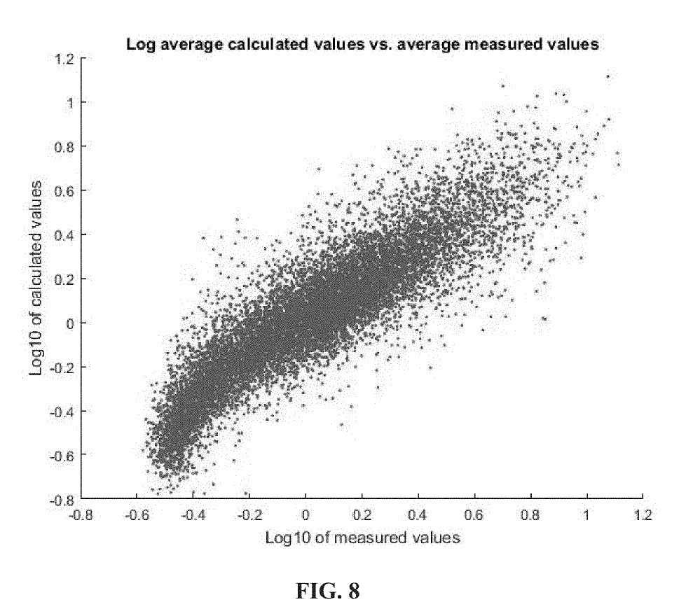

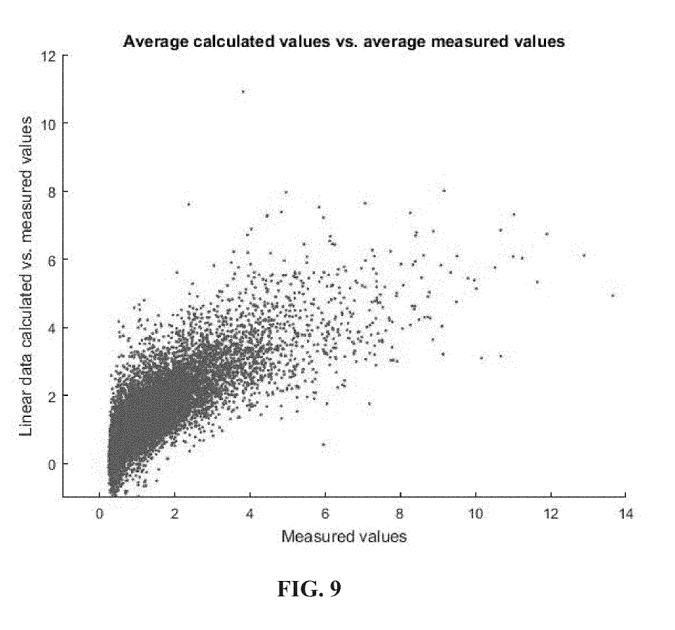

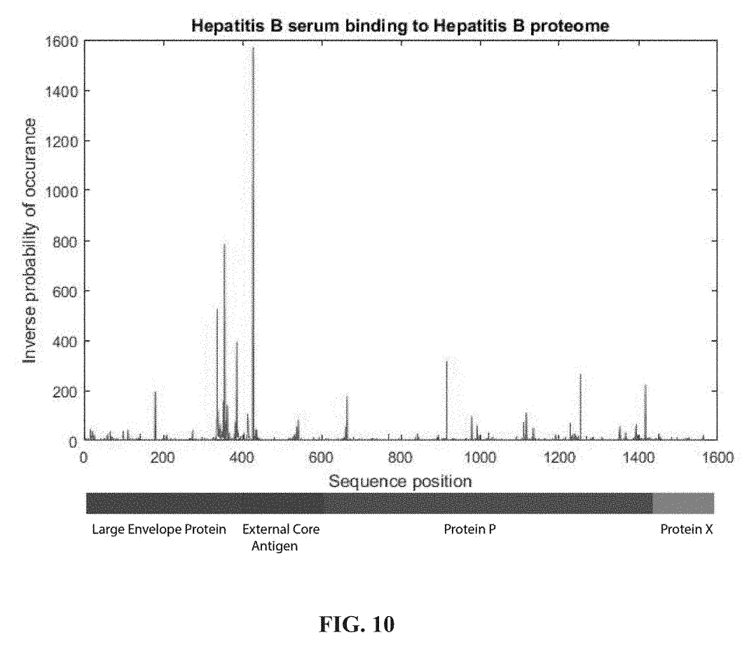

Another application of computational representations of binding is in identifying the antigens involved in disease responses. This is important, both in vaccine production and in the identification of potential drug targets. Shown in FIG. 8 is a fit of the log of the binding values from an average of 44 patients infected with Hepatitis B. The Pearson correlation coefficient between the log of the measured and log of the calculated values is about 0.89. FIG. 9 shows a similar fit of data in the linear form (no log), resulting in a Pearson correlation coefficient of 0.78 between measured and calculated values. The maps and analysis that followed used the linear fits as these emphasis the high binding values. FIG. 10 shows a map of the calculated binding for tiled sequences that make up the Hepatitis B proteome. One can see that there is a region of unusually strong binding in the so-called S-antigen, which is an antigen often used in immunological assays for the disease. However, if one fits an average of 44 patients infected with Hepatitis C, one sees that this region of the Hepatitis B proteome is also higher than average binding in those patients. Using the fact that we can project each of the patient samples onto the Hepatitis B proteome sequence, however, we can overcome this problem.

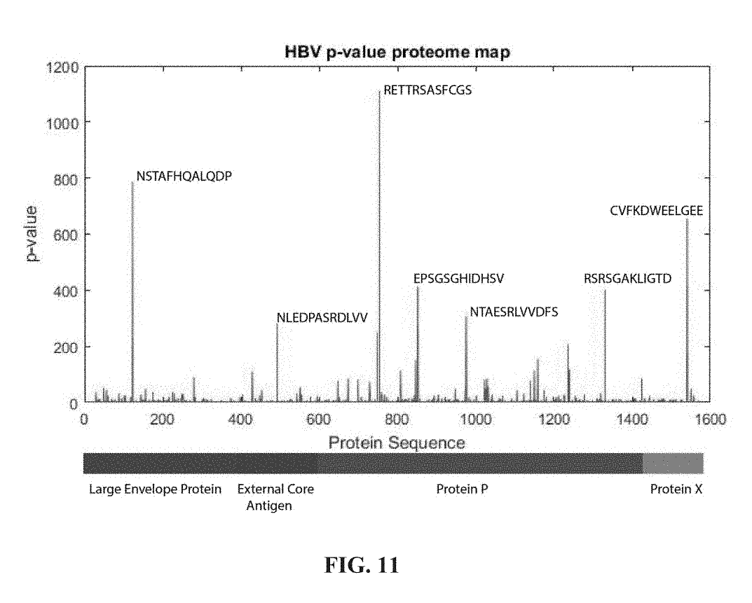

For the current study, the data from an average of all Hepatitis B and C samples was performed and used to determine Q in equation 4. This Q was held constant as each of the individual samples was refit, varying just A. These 88 equations (from the 44 Hepatitis B and 44 Hepatitis C samples) were used in a Ttest to calculate a p-value between Hepatitis B and Hepatitis C calculated values for each peptide window in the Hepatitis B proteome. The p-values were then inverted and plotted against the sequence, showing which peptides had strong differences between patient responses to the two viruses (FIG. 11). A comparison of the sequences highlighted by this approach in the Hepatitis B genome with those noted to be antigens for Hepatitis B from previous studies (the website www.iedb.org supports a database of infectious disease epitopes), showed that several of the predicted epitopes had been previously identified by orthogonal methods.

This demonstrates that it is possible to use projections of the immune response made possible by the fits to equation 4 in order to map potential antigens and epitopes within the sequence of proteins thought to be involved in the disease. This can be applied to the production of vaccines and to the identification of therapeutic targets.

### Example 4 Using Calculated Binding Based on Peptide Arrays to Enhance the Diagnostic Capabilities of Those Arrays

In Example 3, comparing the projection of equations fit using 44 Hepatitis B samples to 44 Hepatitis C samples onto the Hepatitis B proteome made it possible to identify potential antigens and epitopes within the Hepatitis B proteome that distinguish responses to it from patient responses to Hepatitis C. One can take this further by using the calculated values for each sample in a classification analysis as part of a diagnostic to differentiate Hepetitis B and C infections.

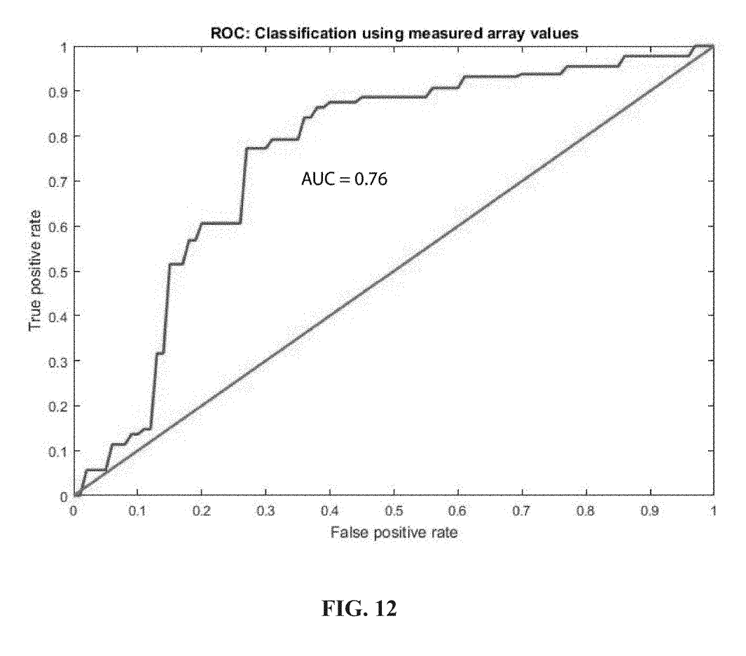

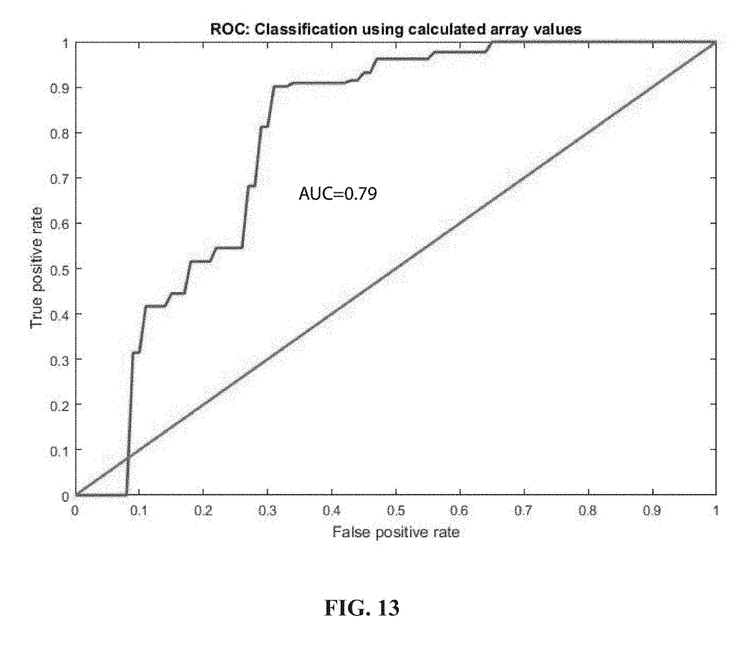

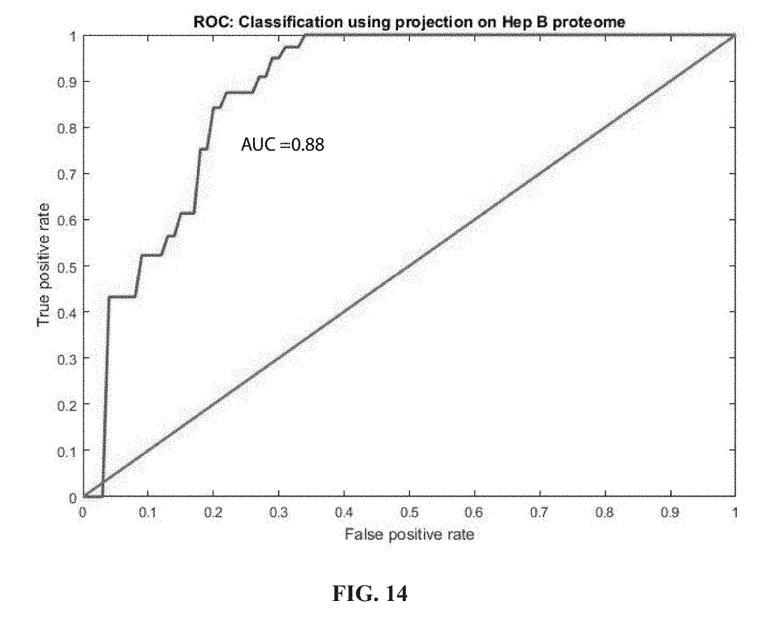

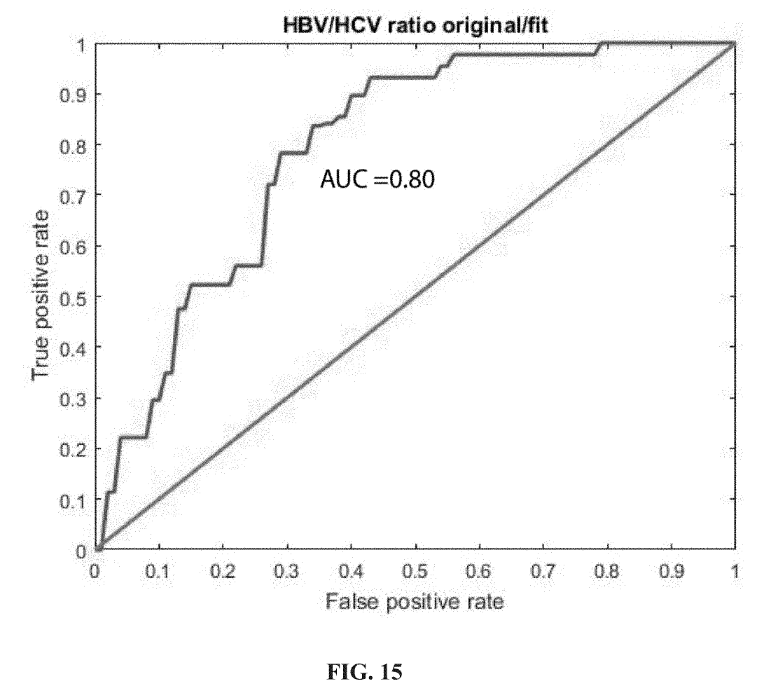

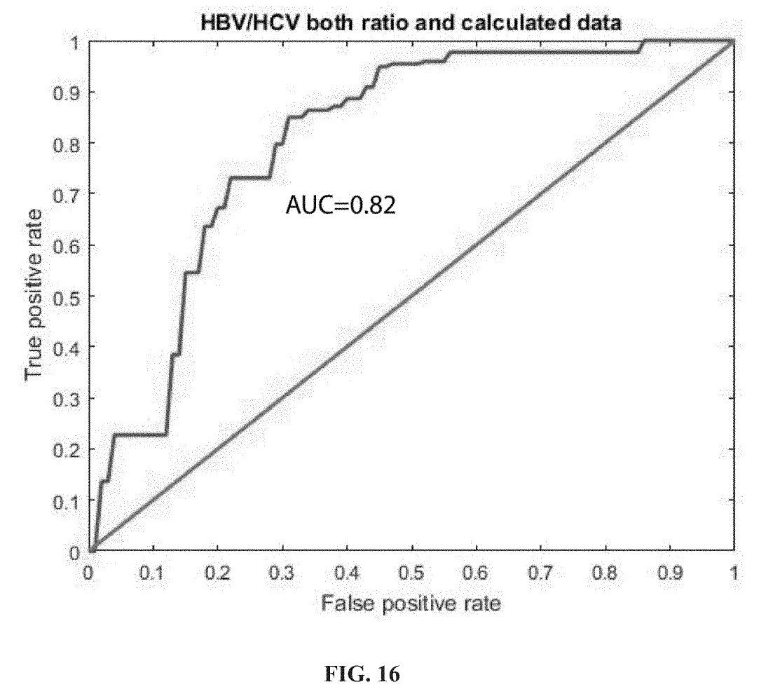

As a reference, the ROC (receiver operator curve) obtained for the measured dataset itself has an area of ˜0.76 (AUC, Table 1, FIG. 12) using Support Vector Machine as the classification approach. (Note, the samples used in this analysis were purposely chosen to be difficult to distinguish making it easier to determine if the application of the algorithm allowed better resolution of the two diseases.) One can also perform the classification using the calculated binding values for the peptides in the original array. This gives a slightly higher AUC (0.79, FIG. 13, Table 1). It is also possible to project the calculation for each sample independently onto the Hepatitis B proteome and then classify using those values. Now the AUC climbs to 0.88 (FIG. 14, Table 1). Clearly using the known biology of the disease to focus the reactivity of the array greatly helps. Interestingly, when the calculated binding is either subtracted from the original data or the ratio between it and the original data is taken, this remaining information also resolves the diseases somewhat better than does the original measured data itself, giving an AUC of 0.80 (FIG. 15, Table 1). Using both the calculated values and the left over values (ratio in this case) in the same classification improves the fit further to about 0.81 AUC (FIG. 16).

TABLE 1
Area Under the ROC curve (average of five analyses)

| Classification type | AUC |
|---|---|
| Classification using original data | 0.76 |
| Classification using original fit and recalculated data | 0.79 |
| Classification using calculated Hepatitis B proteome data | 0.88 |
| Classification using ratio of original to recalculated data | 0.80 |
| Classification using ratio data and recalculated data | 0.81 |

The error in the area under the curve (AUC) is less than 0.01.

Again, a key advantage of having developed an equation to represent the binding of each sample is that it allows one to use our knowledge of biology and chemistry in enhancing the function of the arrays. In this case, we are using the Hepatitis B proteome to focus the information from the original array onto sequences most pertinent to the specific disease analysis. In addition, the information that is extracted during the calculation is apparently inherently different from the disease specific information that is left behind (the information not extracted by the fitting algorithm). As a result, using these two sources of information separately is apparently more powerful as classifying than using either alone.

Those skilled in the art would understand that one could take advantage of the ability to calculate binding to peptides in other ways that would potentially enhance diagnosis or classification. For example, one could perform feature selection not via statistical methods (e.g. ttest) by rather by searching for peptides in the original array that were most sensitive to mutagenesis or that had strong dependence on the order of the amino acids. One could project the equation against very large numbers of random peptides, creating much larger in silico arrays than the original array, potentially finding sequences that would do a better job in classification. One could use this approach, in fact, to design smaller arrays, specific to a particular clinical diagnostic, prognostic or monitoring task. One may also be able to use the elements of the equations in other combinations to create datasets that better differentiated disease as well.

### Example 5: Finding the Binding Site of a Protein to its Receptor

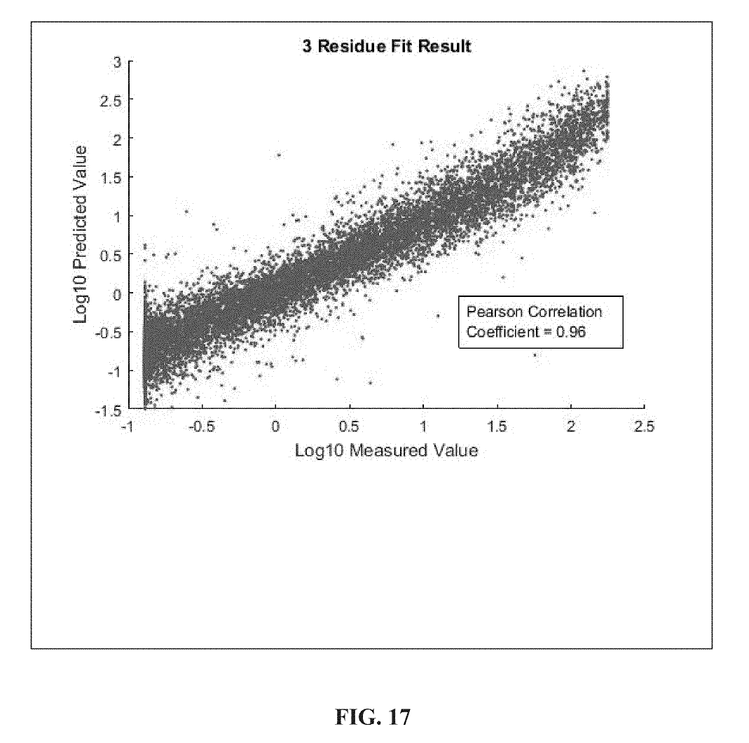

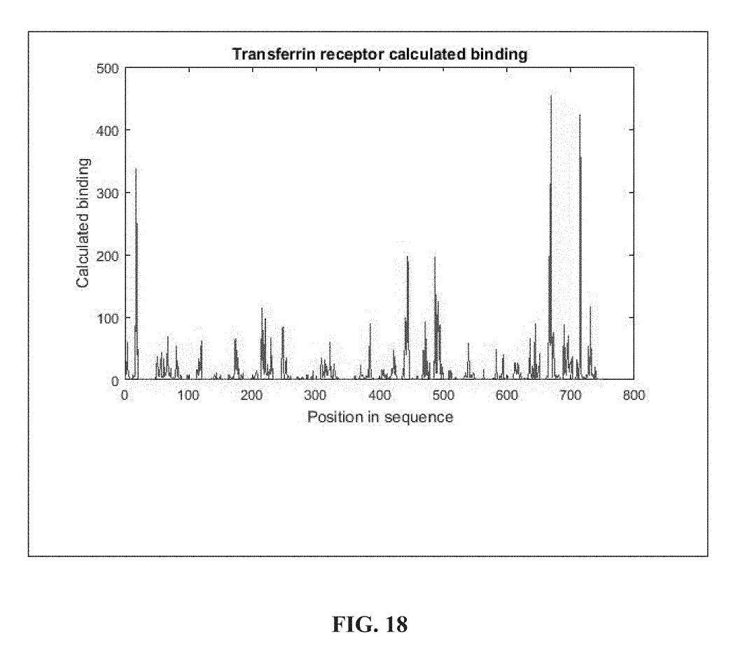

It is also possible to use the peptide array to determine the range of sequences a protein binds to and then use that information to characterize the interaction with its partner. FIG. 17 shows a fit using equation 4 of the data from binding of transferrin to a peptide array containing about 330,000 sequences. The axes are the log of the median normalized measured values (x-axis) vs the log of the median normalized predicted values (y-axis). As with other examples, the points shown are true predictions in that those sequences were held out of the fits and their values predicted. The correlation coefficient between measured and predicted values is 0.96. Using the resulting equation from the fit, one can predict how transferrin might bind to the transferrin receptor (FIG. 18). This complex has been crystalized. As done in previous examples (see the tubulin monoclonal example), one can look at the initial binding prediction (FIG. 18) and then one can use what is known about specific binding to limit that prediction.

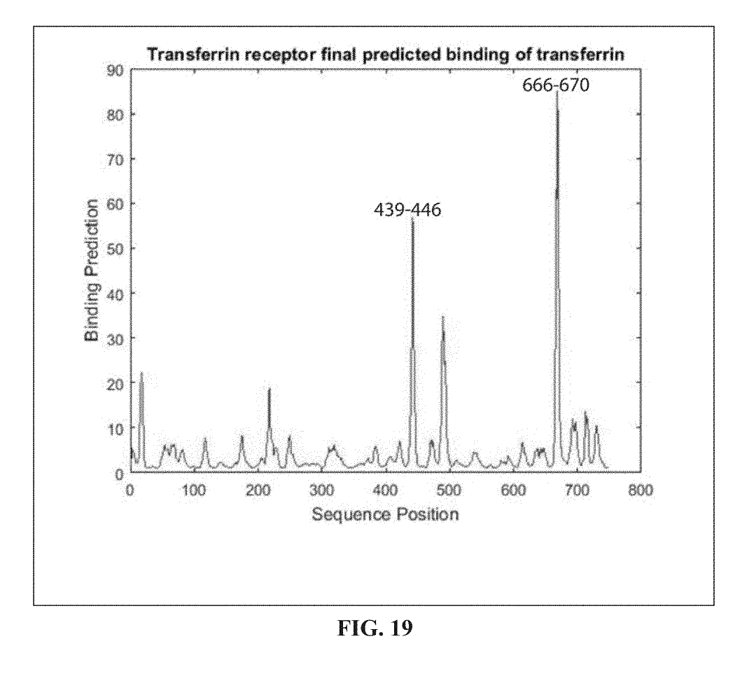

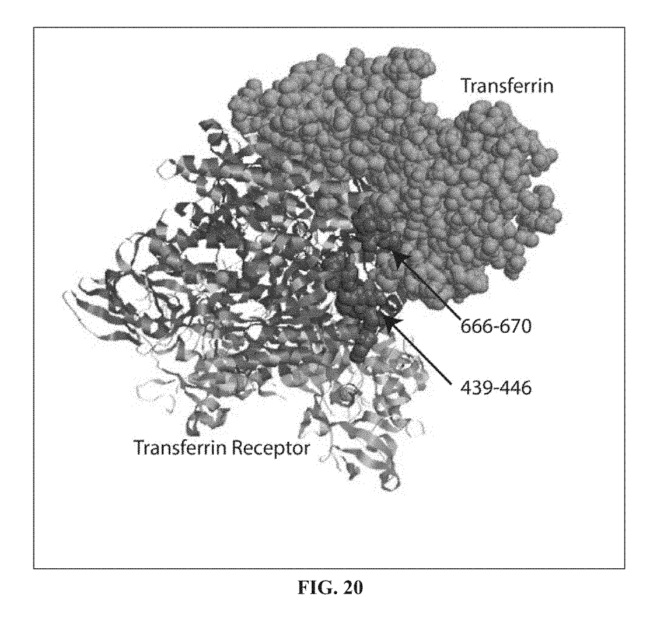

In this case, as with tubulin, it was assumed that the binding would be substantial in multiple consecutive windows of the calculation and that it would be very sensitive to point mutants. With those two constraints the prediction of strongest binding regions includes two relatively prominent features, one of which covers residues 666-670 of the receptor and the other covers the residues 439-446 (FIG. 19). FIG. 20 shows that both of these sequences lie near the interface between transferrin and its receptor, suggesting that this approach has successfully pinpointed a portion of the binding region directly from an array analysis of one of the two partners.

Embodiments herein involve computation utilizing devices programmed to process inputs according to the methods described and provide data outputs.

### Digital Processing Device

In some embodiments, the systems, platforms, software, networks, and methods described herein include a digital processing device, or use of the same. In further embodiments, the digital processing device includes one or more hardware central processing units (CPUs), i.e., processors that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, a digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, a digital processing device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, a digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, a digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

In some embodiments, a digital processing device includes a digital camera. In some embodiments, a digital camera captures digital images. In some embodiments, the digital camera is an autofocus camera. In some embodiments, a digital camera is a charge-coupled device (CCD) camera. In further embodiments, a digital camera is a CCD video camera. In other embodiments, a digital camera is a complementary metal-oxide-semiconductor (CMOS) camera. In some embodiments, a digital camera captures still images. In other embodiments, a digital camera captures video images. In various embodiments, suitable digital cameras include 1-30, and higher megapixel cameras, including increments therein. In some embodiments, a digital camera is a standard definition camera. In other embodiments, a digital camera is an HD video camera. In further embodiments, an HD video camera captures images with at least about 1280× about 720 pixels or at least about 1920× about 1080 pixels. In some embodiments, a digital camera captures color digital images. In other embodiments, a digital camera captures grayscale digital images. In various embodiments, digital images are stored in any suitable digital image format. Suitable digital image formats include, by way of non-limiting examples, Joint Photographic Experts Group (JPEG), JPEG 2000, Exchangeable image file format (Exif), Tagged Image File Format (TIFF), RAW, Portable Network Graphics (PNG), Graphics Interchange Format (GIF), Windows® bitmap (BMP), portable pixmap (PPM), portable graymap (PGM), portable bitmap file format (PBM), and WebP. In various embodiments, digital images are stored in any suitable digital video format. Suitable digital video formats include, by way of non-limiting examples, AVI, MPEG, Apple® QuickTime®, MP4, AVCHD®, Windows Media®, DivX™, Flash Video, Ogg Theora, WebM, and RealMedia.

### Non-Transitory Computer Readable Storage Medium

In some embodiments, the systems, platforms, software, networks, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the systems, platforms, software, networks, and methods disclosed herein include at least one computer program. A computer program includes a sequence of instructions, executable in the digital processing device's CPU, written to perform a specified task, such as those in the algorithms disclosed herein. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™ JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. A web application for providing a career development network for artists that allows artists to upload information and media files, in some embodiments, includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

The systems, platforms, software, networks, and methods disclosed herein include, in various embodiments, software, server, and database modules. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

While the preferred embodiments of the present invention have been illustrated in detail, it should be apparent that modification and adaptations to those embodiments may occur to one skilled in the art without departing from the scope of the present invention.

### Sequence Listing Statement

The application includes the sequence listing that is concurrently filed in computer readable form. This sequence listing is incorporated by reference herein.

### REFERENCES

1. Diehnelt, C. W., Peptide array based discovery of synthetic antimicrobial peptides. Front Microbiol, 2013. 4: p. 402.
2. Diehnelt, C. W., et al., Discovery of High-Affinity Protein Binding Ligands—Backwards. Plos One, 2010. 5(5).
3. Domenyuk, V., et al., A Technology for Developing Synbodies with Antibacterial Activity. Plos One, 2013. 8(1).
4. Greving, M. P., et al., High-throughput screening in two dimensions: Binding intensity and off-rate on a peptide microarray. Analytical Biochemistry, 2010. 402(1): p. 93-95.
5. Greving, M. P., et al., Thermodynamic Additivity of Sequence Variations: An Algorithm for Creating High Affinity Peptides Without Large Libraries or Structural Information. Plos One, 2010. 5(11).
6. Gupta, N., et al., BIOL 183-Synbodies: Progress toward development of synthetic affinity agents. Abstracts of Papers of the American Chemical Society, 2008. 236.
7. Gupta, N., et al., Engineering a Synthetic Ligand for Tumor Necrosis Factor-Alpha. Bioconjugate Chemistry, 2011. 22(8): p. 1473-1478.
8. Gupta, N., et al., Synthetic ligands (synbodies): Synthetic alternatives to antibodies. Abstracts of Papers of the American Chemical Society, 2010. 240.
9. Lainson, J. C., et al., Conjugation Approach To Produce a Staphylococcus aureus Synbody with Activity in Serum. Bioconjugate Chemistry, 2015. 26(10): p. 2125-2132.
10. Williams, B. A. R., et al., Creating Protein Affinity Reagents by Combining Peptide Ligands on Synthetic DNA Scaffolds. Journal of the American Chemical Society, 2009. 131(47): p. 17233-17241.
11. Legutki, J. B. and S. A. Johnston, Immunosignatures can predict vaccine efficacy. Proceedings of the National Academy of Sciences of the United States of America, 2013. 110(46): p. 18614-18619.
12. Legutki, J. B., et al., Scalable High-Density Peptide Arrays for Comprehensive Health Monitoring. Nature Communications, 2014. 5: p. 4785.
13. Stafford, P., D. Wrapp, and S. A. Johnston, General Assessment of Humoral Activity in Healthy Humans. Molecular & Cellular Proteomics, 2016. 15(5): p. 1610-1621.
14. Singh, S., et al., Humoral Immunity Profiling of Subjects with Myalgic Encephalomyelitis Using a Random Peptide Microarray Differentiates Cases from Controls with High Specificity and Sensitivity. Mol Neurobiol, 2016.

1. A method for relating the structure of a molecule in a library to its function by analyzing experimental data from a library comprising one or more chemical structures, the method comprising:
(a) obtaining a data set associated with said one or more chemical structures based on a signal derived from interaction of said one or more chemical structures with a physical phenomenon of interest; and
(b) applying a model description to said data set that enables determination of a function of said molecule in the library according to values representing its covalent structure, one or more components of that structure, and one or more properties of said components as they relate to the function in question.

2. The method of claim 1, wherein the model description comprises:
f_{n(sequence)}=ΣₘΣᵣΣₖC_{n,m,r}Q_{k,m}A_{k,r}
wherein fₙ is the function of the nth molecule in the library, C_{n,m,r} is a description of the covalent structure of the molecule where n is a specific molecule in the library, m represents chemical entities that make up the specific molecule and r represents the positions of a set of structural elements made from those entities, Q_{k,m} represents the assignment of properties to the chemical entities, whereby there are k properties assigned to each of the m chemical entities, and A_{k,r} represents the weighting coefficient assigned to different functional components of the molecule in terms of their properties.

3. The method of claim 1, wherein the model description comprises:
f_{n(sequence)}=α₀+α₁ΣₘΣᵣΣₖC_{n,m,r}Q_{k,m}A_{k,r}+α₂(ΣₘΣᵣΣₖC_{n,m,r}Q_{k,m}A_{k,r})(ΣₘΣᵣΣₖC_{n,m,r}Q_{k,m}A_{k,r})+α₃(ΣₘΣᵣΣₖC_{n,m,r}Q_{k,m}A_{k,r})(ΣₘΣᵣΣₖC_{n,m,r}Q_{k,m}A_{k,r})(ΣₘΣᵣΣₖC_{n,m,r}Q_{k,m}A_{k,r})+
wherein αᵢ is a multiplier of the term, fₙ is the function of the nth molecule in the library, C_{n,m,r} is a description of the covalent structure of the molecule where n is a specific molecule in the library, m represents chemical entities that make up the specific molecule and r represents the positions of a set of structural elements made from those entities, Q_{k,m} represents the assignment of properties to the chemical entities, whereby there are k properties assigned to each of the m chemical entities, A_{k,r} represents the weighting coefficient assigned to different functional components of the molecule in terms of their properties, and the A and Q matrices can either be held constant in every sum or different values can be used in each sum.

4. The method of claim 1, wherein said physical phenomenon comprises an interaction between a molecule or molecules of interest with said one or more chemical structures.

5. The method of claim 4, wherein said signal comprises imaging of said interaction between the one or more chemical structures and the molecule or molecules of interest.

6. The method of claim 5, wherein said imaging is of a florescent marker associated with said molecule or molecules of interest.

7. The method of claim 1, wherein said applying is performed with a specially programmed digital processing device that includes one or more non-transitory computer readable storage media encoded with one or more programs that processes information about interaction of said one or more chemical structures with the physical phenomenon of interest according to said model description.

8. A method relating the structure of a peptide in a library to its function by analyzing experimental data from a library comprising one or more peptides, the method comprising:
(a) obtaining a data set associated with said one or more peptides based on a signal derived from interaction of said one or more peptides with an added molecule or molecules of interest; and
(b) applying a model description to said data set that enables determination of a function of said peptide in the library according to values representing its covalent structure, one or more components of that structure, and one or more properties of said components as they relate to the function in question.

9. The method of claim 8, wherein the model description comprises:
f_{n(sequence)}=ΣₘΣᵣΣₖC_{n,m,r}Q_{k,m}A_{k,r},
wherein fₙ is the function of the nth molecule in the library, C_{n,m,r} is a description of the covalent structure of the molecule where n is a specific molecule in the library, m represents chemical entities that make up the specific molecule and r represents the positions of a set of structural elements made from those entities, Q_{k,m} represents the assignment of properties to the chemical entities, whereby there are k properties assigned to each of the m chemical entities, and A_{k,r} represents the weighting coefficient assigned to different functional components of the molecule in terms of their properties.

10. The method of claim 8, wherein the model description comprises:
f_{n(sequence)}=α₀+α₁ΣₘΣᵣΣₖC_{n,m,r}Q_{k,m}A_{k,r}+α₂(ΣₘΣᵣΣₖC_{n,m,r}Q_{k,m}A_{k,r})(ΣₘΣᵣΣₖC_{n,m,r}Q_{k,m}A_{k,r})+α₃(ΣₘΣᵣΣₖC_{n,m,r}Q_{k,m}A_{k,r})(ΣₘΣᵣΣₖC_{n,m,r}Q_{k,m}A_{k,r})(ΣₘΣᵣΣₖC_{n,m,r}Q_{k,m}A_{k,r})+
wherein αᵢ is a multiplier of the term, fₙ is the function of the nth molecule in the library, C_{n,m,r} is a description of the covalent structure of the molecule where n is a specific molecule in the library, m represents chemical entities that make up the specific molecule and r represents the positions of a set of structural elements made from those entities, Q_{k,m} represents the assignment of properties to the chemical entities, whereby there are k properties assigned to each of the m chemical entities, A_{k,r} represents the weighting coefficient assigned to different functional components of the molecule in terms of their properties, and the A and Q matrices can either be held constant in every sum or different values can be used in each sum.

11. The method of claim 8, wherein said molecule or molecules of interest comprise antibodies.

12. The method of claim 8, wherein said signal comprises imaging of said interaction between the one or more peptides and the added molecule or molecules of interest.

13. The method of claim 12, wherein said imaging is of a florescent marker associated with said molecule or molecules of interest.

14. The method of claim 8, wherein said applying is performed with a specially programmed digital processing device that includes one or more non-transitory computer readable storage media encoded with one or more programs that processes information about interaction of said one or more peptides with the added molecule or molecules of interest according to said model description.

15. The method of claim 9 or 10, wherein m and r designate specific amino acids at specific positions in a sequence, or wherein m represents groups of amino acids and r represents groups of structural arrangements of those amino acids.
